(19) United States
(12) Patent Application Publication
(10) Pub. No.: US 2019/0061706 A1
(43) Pub. Date: Feb. 28, 2019

(54) Stabilization Device

(71) Applicant: ACK Investments, L.L.C., Freedom, WY (US)

(72) Inventors: Angela Kirby, Freedom, WY (US); Clair Kirby, Freedom, WY (US)

(21) Appl. No.: 16/013,656

(22) Filed: Jun. 20, 2018

Related U.S. Application Data
(60) Provisional application No. 62/549,943, filed on Aug. 24, 2017.

(51) Int. Cl. B60S 9/04

(52) U.S. Cl. CPC B60S 9/04

(57) ABSTRACT

A method and system for supporting and/or stabilizing a recreational vehicle is disclosed. A cargo stabilization bar, load lock bar, cargo bar, or jack bar is oriented vertically and placed so that the bottom end of the cargo stabilization bar is supported by the ground or other stable base. The cargo stabilization bar is extended so that is the top end of the cargo stabilization bar is at a height so that it can support the recreational vehicle through contact with a support point on the recreational vehicle.

### BACKGROUND OF THE INVENTION

Users of RV (recreational vehicle) trailers, also known as “campers” and “fifth wheels,” must stabilize their RV trailer when it is stationed or positioned for use, e.g., camping, sleeping, preparing food, relaxing, or any other use of an RV trailer. As a note, “RV trailer,” as used herein, refers to generally to any trailer, camper, fifth wheel, or other apparatus or device that may be pulled behind or on a car, truck, or other vehicle.

Stabilization is often accomplished by placing a post or rod or other sturdy device underneath one or more sides or parts or locations of the RV Trailer. Such devices must be positioned and then adjusted to the proper height to provide the desired stabilization without raising the RV Trailer or pushing it up too high or off the ground. One drawback of some stabilization devices is an inconvenient, unwieldy, or uncomfortable adjustment mechanism, or an adjustment mechanism involving parts that are limited to discrete (i.e., non-continuous) adjustment positions, or an adjustment mechanism in which gravity may cause undesirable movement during adjustment or while the device is being configured for adjustment.

What is needed is a better RV trailer stabilization device and method.

### BRIEF SUMMARY OF THE INVENTION

A method and system for supporting and/or stabilizing a recreational vehicle is disclosed. A cargo stabilization bar, load lock bar, cargo bar, or jack bar is oriented vertically and placed so that the bottom end of the cargo stabilization bar is supported by the ground or other stable base. The cargo stabilization bar is extended so that is the top end of the cargo stabilization bar is at a height so that it can support the recreational vehicle through contact with a support point on the recreational vehicle.

### BRIEF DESCRIPTION OF THE DRAWINGS

FIG. 1 shows a side-angle view of an exemplary stabilization device.

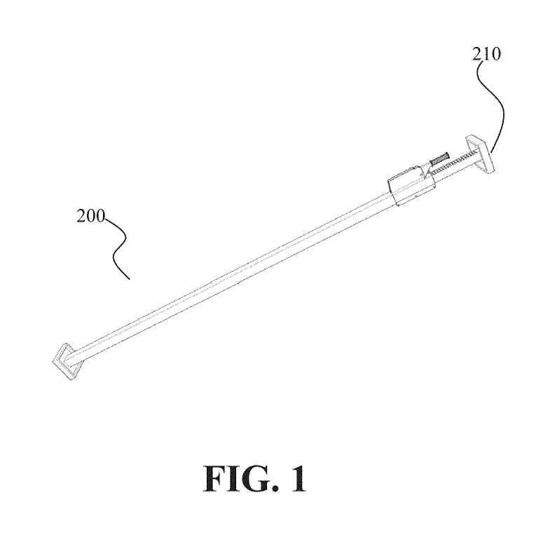

FIG. 2 shows a rear-angle view of an exemplary RV Trailer.

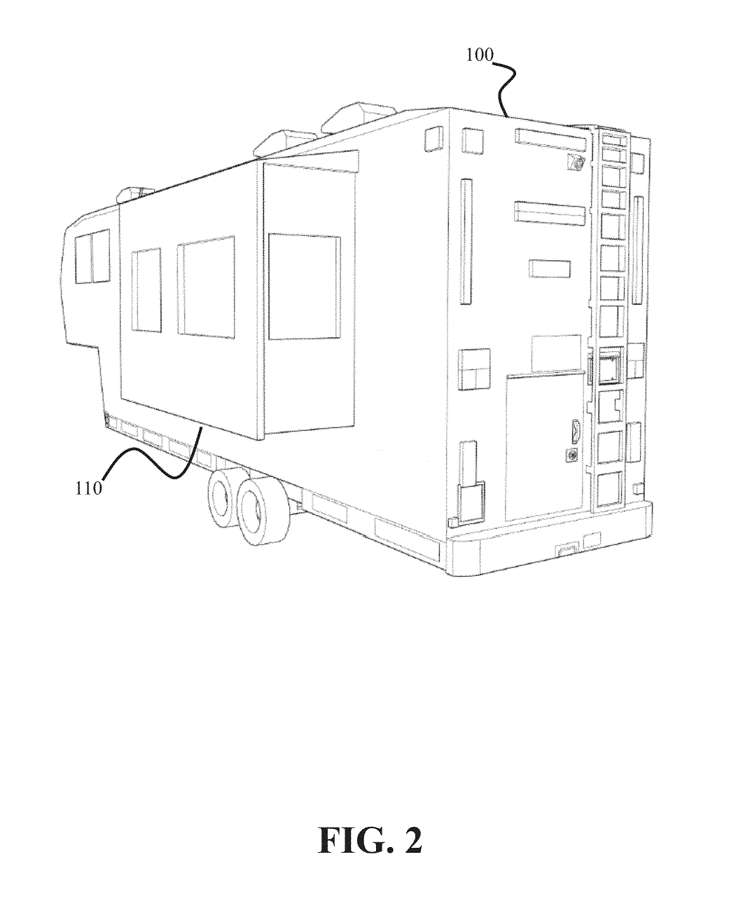

FIG. 3 shows a rear view of an exemplary RV Trailer.

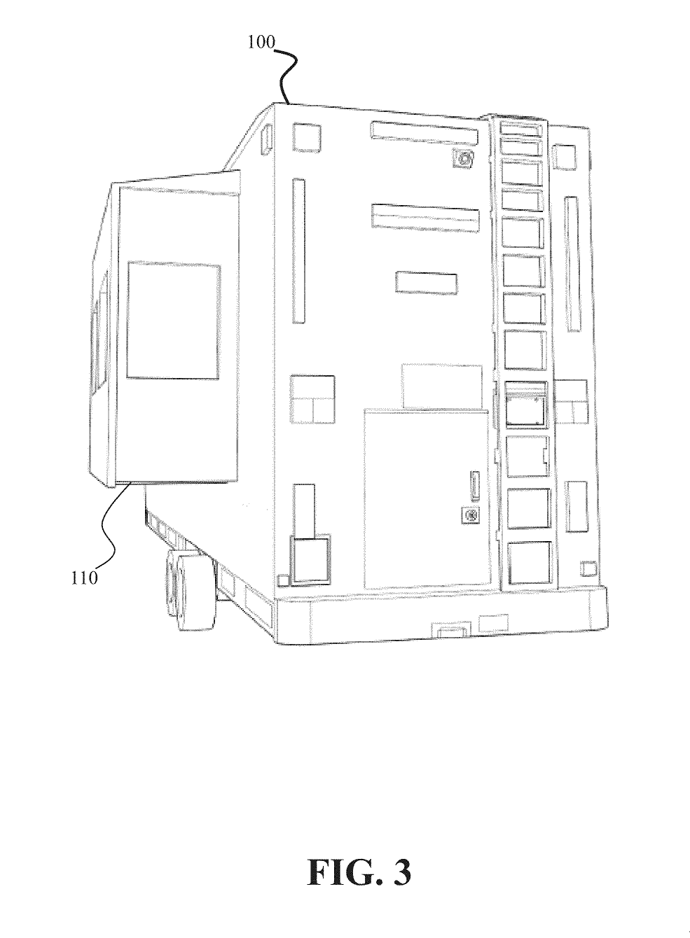

FIG. 4 shows a rear-angle view of an exemplary RV Trailer with a stabilization device under a support point on the RV Trailer but not actually touching or supporting the RV Trailer.

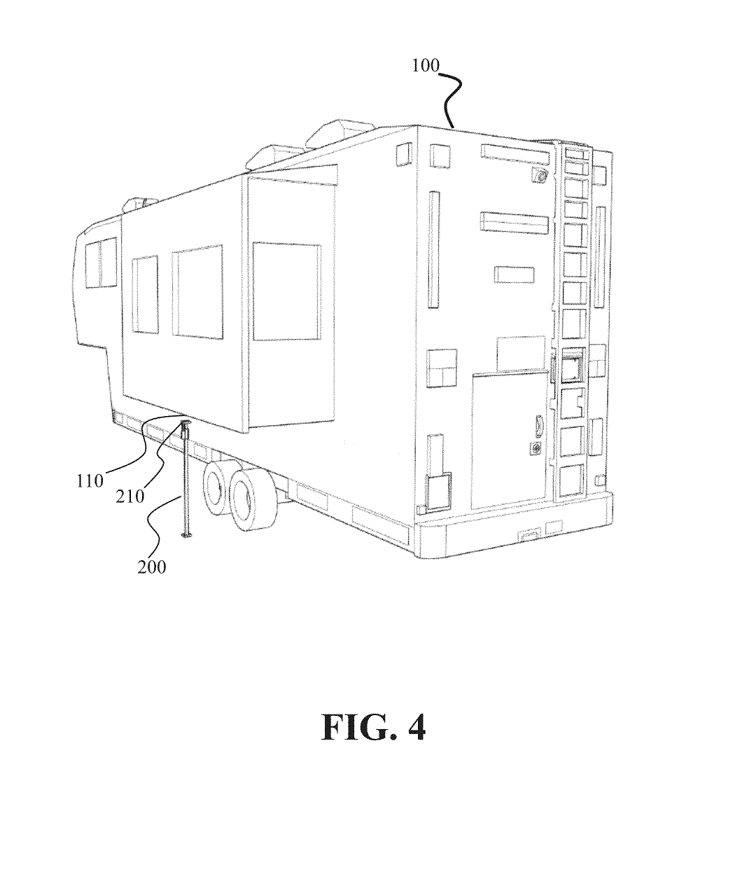

FIG. 5 shows a rear view of an exemplary RV Trailer with a stabilization device under a support point on the RV Trailer but not actually touching or supporting the RV Trailer.

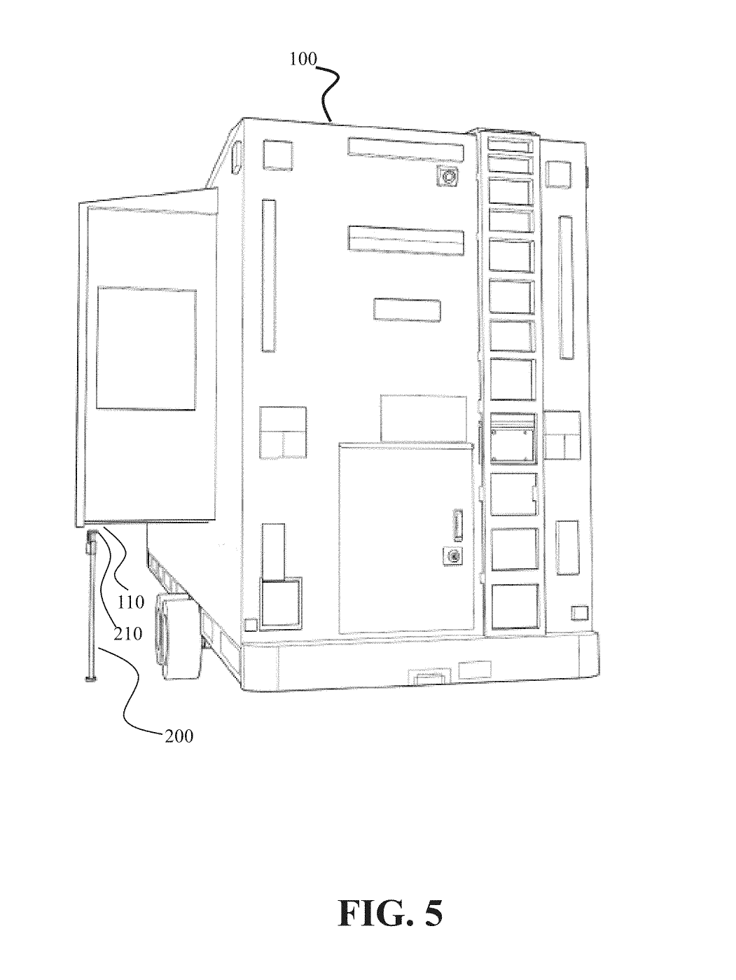

FIG. 6 shows a rear-angle view of an exemplary RV Trailer with a stabilization device deployed and supporting the RV Trailer under a support point on the RV Trailer.

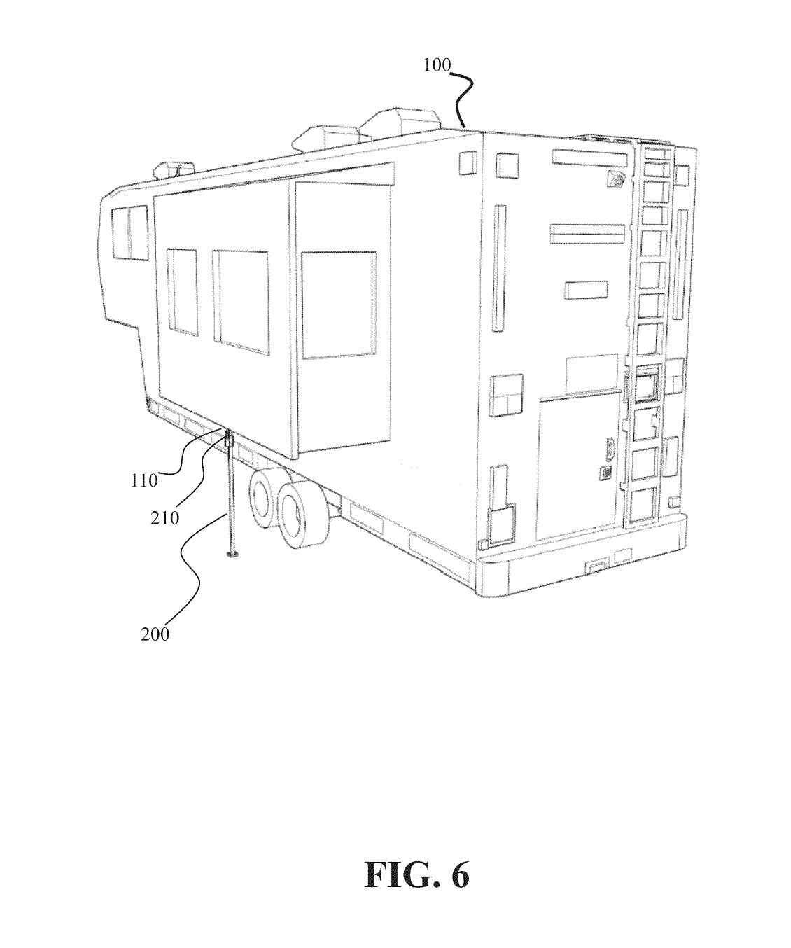

FIG. 7 shows a rear view of an exemplary RV Trailer with a stabilization device deployed and supporting the RV Trailer under a support point on the RV Trailer.

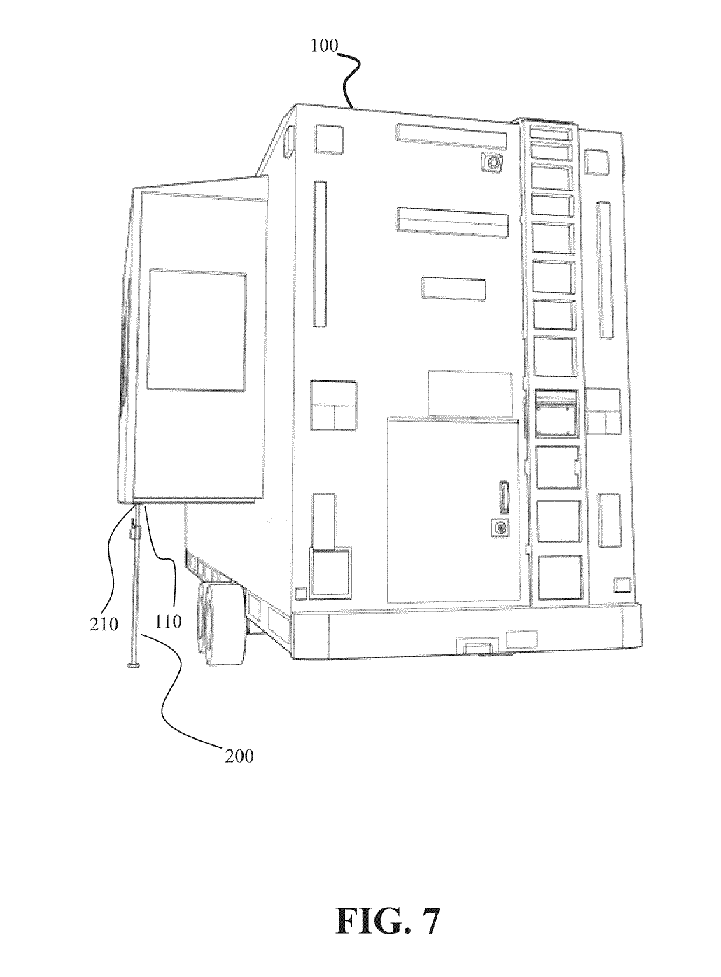

FIG. 8 shows a flowchart for an exemplary method for using the apparatus as disclosed herein.

### DETAILED DESCRIPTION OF THE INVENTION

This application claims priority to U.S. Provisional Application No. 62/549,943, filed on Aug. 24, 2017, which is titled “Stabilization Device,” the first inventor of which is Angela Kirby, and which is incorporated herein by reference in its entirety.

An improved RV trailer stabilization device and method are disclosed herein.

### TABLE OF REFERENCE NUMBERS FROM DRAWINGS

The following table is for convenience only, and should not be construed to supersede any potentially inconsistent disclosure herein.

| Reference | |
|---|---|
| Number | Description |
| 100 | RV Trailer |
| 110a-n | support points on RV Trailer |
| 200 | stabilization device |
| 210 | contact point |
| 220 | adjustment mechanism |

Although the disclosure herein focuses on stabilization of an RV trailer, it should be recognized that the disclosed methods and apparatuses may be applied without material alteration to vehicles such as a motor coach, truck, van, bus, tour bus, rig, semi, tractor, pickup, car, jeep, wagon, boat, carrier, automobile, car, or other vehicle or structure in need of vertical stabilization or support.

In one embodiment, the disclosed stabilization device may be used to support and/or stabilize RV trailers, such as when an RV trailer is extended, or slid out (e.g., slide outs), including slides, pop outs, slide outs, tail gates, fifth wheel supports, and any other situations that may arise in which it may be necessary, desirable, or useful to vertically support some or all of an RV trailer.

One embodiment of the disclosed stabilization method may comprise using a cargo stabilization bar for vertically stabilizing and/or supporting an RV trailer as described herein. A cargo stabilization bar may be referred to as a load lock bar, cargo bar, jack bar, or any, other term. Cargo stabilization bars are currently used at least for stabilizing cargo, e.g., inside an eighteen-wheeler, pickup truck, large trailer, train cargo car, or in other cargo shipping or movement applications.

A cargo stabilization bar may extend, shorten, and or adjust by ratcheting, telescoping, ribbed bar extension, quick release system, a series of ratchets, a series of recesses via pumping, a jacking motion, pneumatic air, or other cargo bar adjustment solutions.

A cargo stabilization may have contact points on either end. These contact points may be referred to as “feet.” In one embodiment, the feet on either end of a cargo stabilization bar may comprise a planar surface, and may be covered by rubber or another non-grip material, in various shapes, textures, and/or configurations, as known in the art.

In this embodiment, a cargo stabilization bar may be placed, vertically oriented, underneath a desired stabilization/support point, and may be adjusted to the desired height. In one embodiment, a support such as wood blocks may be placed above or beneath the cargo stabilization bar to distribute weight and/or provide other stabilization benefits.

In one alternative, the cargo stabilization bar may be adjusted prior to placement under the load point, and may be adjusted again after placement under the load point.

In one embodiment, a cargo adjustment bar with a non-slide mechanism may be used so that the cargo adjustment bar may be released from a locked or set configuration, e.g., at the desired height to appropriately stabilize an RV trailer, but without dropping when released. For example, the cargo adjustment bar may adjust downward slowly by gravity or dampening, or downward adjustment may happen by one of the adjustment mechanisms described herein.

Many different types of cargo stabilization bars, or other adjustment devices, or stabilization devices, may be used to implement and/or practice the method disclosed herein.

For example, a stabilization device may comprise a jack that is a telescoping apparatus including an external tube, an internal tube, a mount, a toothed wheel, a handle, a first detent and a second detent. The internal tube may be telescopically inserted in the external tube and formed with a series of recesses. The mount may be secured to the external tube. The toothed wheel may be supported on the mount and formed with teeth for insertion in the recesses. The handle may be supported on the mount. The first detent may be movably located on the mount and formed with a ratchet for engagement with the teeth. The second detent may be movably located on the mount and formed with a ratchet for engagement with the teeth. A damping unit may be located on the mount for damping the spinning of the toothed wheel and, therefore, the insertion of the internal tube. An example of such a stabilization device is shown and described in detail in U.S. Pat. No. 8,490,930 to Huang, which is incorporated herein by reference.

In another exemplary embodiment, a stabilization device may comprise a load support apparatus comprising a housing on which a suspension device is mounted for movement between an operative load suspension position and an inoperative relaxed position. Also mounted on the housing may be a holding bolt which is movable between a first position in which a load is supported by the holding bolt and a second position in which the load is released from the bolt. A displaceable locking bar may be mounted in the housing for movement transversely of the displacement path of the holding bolt for engaging the bolt to lock the same in the position in which the load is supported by the holding bolt. A catch mechanism may be displaceably mounted on the housing for locking the locking bar and a control mechanism responsive to the position of the suspension device may operate to displace the catch mechanism to lock the locking bar in the position in which the holding bolt is locked when the suspension device is in its operative load suspension position. An example of such a device is shown and described in detail in U.S. Pat. No. 4,453,622 to Betz, which is incorporated herein by reference.

In another exemplary embodiment, a stabilization device may comprise a cargo bar including a telescoping rod composed of an outer tube and an inner tube. One end of a toothed rail may be fastened on the inner tube and the other end thereof may longitudinally extend along the outer tube so that the toothed rail can move with the inner tube. An iron assembly, composed of a housing and a U-shaped bracket, may be fixed at one end of the outer tube. A U-shaped bracket may accommodate the toothed rail and pivotally connect a handle. A plurality of cogs may be formed on the pivotal end of the handle. When the handle is closed, the cogs may engage with the toothed rail so as to jam the inner tube. That is, the total length formed by the two tubes stays fixed. When the handle is opened, the cogs may disengage with the toothed rail so as to make the inner tube become adjustable. An example of such a device is shown and described in detail in U.S. Pat. No. 8,202,029 to Chou, which is incorporated herein by reference.

In another exemplary embodiment, a stabilization device may comprise a cargo bar having high load strength. The cargo bar may generally comprise an outer sheath and an inner cylindrical telescoping portion. The telescoping portion may have a ribbed section with ribs formed from the walls of the telescoping portion. Fastened to the outer sheath may be a handle mechanism comprising a handle frame and a lever, the lever having teeth for gripping the ribs of the inner telescoping portion. The handle may be moved from an open position to a closed position, thereby extending the inner portion away from the outer portion through the interaction of the teeth with the ribs of the inner bar. Increased strength may be provided by the ribs formed from the walls of the telescoping portion. An example of such a device is shown and described in detail in U.S. Pat. No. 8,118,525 to Long, which is incorporated herein by reference.

An additional exemplary stabilization devices is disclosed in U.S. Patent Application Publication No. US 20060051179, which is incorporated herein by reference.

In another exemplary embodiment, a stabilization device may comprise a dunnage jack bar assembly of the longitudinal ratchet type wherein the length of the jack bar assembly is adjusted by a carriage slidably mounted upon the jack bar having locking and power pawls operated by an oscillating operating lever wherein the pawls engage the teeth of the jack bar to translate the carriage thereon. A quick release lever mounted upon the operating lever selectively, may lift the locking pawl from the jack bar teeth to permit a rapid translation of the carriage on the jack bar in either direction. An example of such a device is shown and described in detail in U.S. Pat. No. 5,979,876 to Cardona, which is incorporated herein by reference.

In another exemplary embodiment, a stabilization device may comprise an outer tube, an inner tube and a positioner tube coaxially located. The positioner tube may be extendable to adjust a length to the jack bar in use while enabling the jack bar to be retracted for storage. The jack bar may further include a clamp configured to receive tubes of various shapes. The clamp may be further configured to prevent twisting or turning of clamped tubes. An example of such a device is shown and described in detail in U.S. Pat. No. 7,311,294 to Ruan, which is incorporated herein by reference.

In another exemplary embodiment, a stabilization device may comprise the “DC Cargo Mall 86-104 Inches Long Heavy Duty Steel Load Lock Jack Bar Freight Tie-Down for Enclosed Trailers, Reefers, and Cargo Vans” as available on Amazon.com on Jul. 19, 2017 at https://www.amazon.com/DC-Cargo-Mall-86-Tie-Down/dp/B0176NX9MO/ref-sr_1_1?ie=UTF8&qid=1484607501&sr=8-1&keywords=jack+bar, which is incorporated herein by reference.

In another exemplary embodiment, a stabilization device may comprise the “Uline Steel Load Bar” as available at https://www.uline.com/Product/Detail/H-1413/Dock-Equipment/Steel-Load-Bar-87-119?pricode-WY575&gadtype=pla&id=H-1413&gclid=COrxhc3ix9ECFUpNfgodusQDww&gclsrc=aw.ds on Jul. 19, 2017, which is incorporated herein by reference.

In another exemplary embodiment, a stabilization device may comprise the “Kinedyne JB101 Adjustable Cargo Jack Bar” as available at https://www.amazon.com/Kinedyne-JB101-Adjustable-Cargo-Jack/dp/B000XPUTA8 on Jul. 19, 2017, which is incorporated herein by reference.

In another exemplary embodiment, a stabilization device may comprise the “Lode Metals Trench Shoring Bar” as available at https://www.lodimetals.com/trench-shoring-bar on Jul. 19, 2017, which is incorporated herein by reference.

In one embodiment, gears may be on the outside of the stabilization device.

A stabilization device may be modified to be many various lengths, or to be adjustable to many varying lengths. For example, the shaft or adjustable segment of a stabilization device may be shortened or lengthened to suit a particular application of the stabilization device. Any of the exemplary devices described and/or referenced herein may be lengthened or shortened to be suitable for a particular application.

In one embodiment, a stabilization device may be built into or stored in an RV Trailer. For example, a stabilization device may be built into an RV Trailer by attaching the stabilization device to the RV Trailer using a swing down hinge. In this embodiment, the stabilization device may swing up to be stored under the RV Trailer when not in use, and may latch or be secured in some other manner so that the stabilization device remains in the storage position, i.e., horizontal to the ground. In a similar embodiment, a stabilization device may slide up into an RV Trailer for storage when not in use. In these embodiments, i.e., built in to the RV Trailer, the stabilization device may employ similar designs and features as the stabilization devices disclosed herein that are not built into or attached to the RV Trailer.

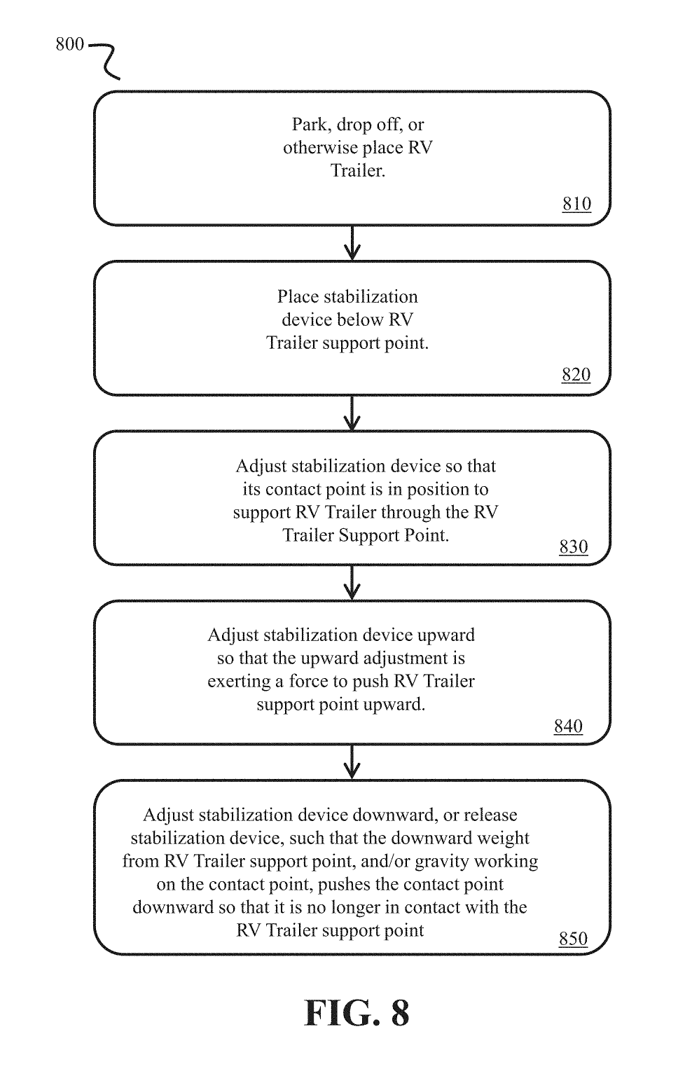

In one exemplary method 800, as shown in FIG. 8, a stabilization device may be used to stabilize and/or support an RV Trailer.

At step 810 RV Trailer 100 may be parked, dropped off, or otherwise placed in a stationary position.

At step 820, stabilization device 200 may be placed underneath support point 100n on RV Trailer 100.

At step 830, stabilization device 200 may be adjusted using adjustment mechanism so that contact point 210 is supporting, or is in a position to support, RV Trailer 100 through support point 110n.

At step 840, stabilization device 200 may be adjusted upward, while contact point 210 is in contact with support point 110n, so that the upward adjustment is exerting a force to push support point 110n upward.

At step 850, stabilization device 200 may be adjusted downward, or released, such that the downward weight from support point 110n, and/or gravity working on contact point 210, pushes contact point downward so that it is no longer in contact with support point 110n.

In this manner, stabilization device 200 may be used to support and/or stabilize RV Trailer 100.

What is claimed is:

1. A method for stabilizing a structure, comprising:
positioning a cargo stabilization bar, vertically oriented, underneath a support point of the structure;
extending the cargo stabilization bar so that a bottom end of the cargo stabilization bar is supported by a stable base and so that that a top end of the cargo stabilization bar is at an elevation to stabilize the structure through the support point.

2. The method of claim 1, further comprising bringing the top end of the cargo stabilization bar into contact with the support point.

3. The method of claim 1, further comprising contracting the stabilization bar so that it is no longer supporting the structure.

4. The method of claim 1, wherein the structure is a recreational vehicle.

5. The method of claim 4, wherein:
the recreational vehicle has at least one slide-out; and
the support point is on the slide-out.

6. The method of claim 1, wherein the stable base is the ground.

7. The method of claim 1, wherein the cargo stabilization bar is a load bar.

8. The method of claim 1, where in the cargo stabilization bar includes a dampening mechanism.

9. A method for supporting a structure, comprising:
positioning a cargo stabilization bar, vertically oriented, underneath a support point of the structure;
extending the cargo stabilization bar so that a bottom end of the cargo stabilization bar is supported by a stable base and so that that top end of the cargo stabilization bar is at an elevation to support the structure through the support point.

10. The method of claim 9, further comprising bringing the top end of the cargo stabilization bar into contact with the support point.

11. The method of claim 9, further comprising contracting the stabilization bar so that it is no longer supporting the structure.

12. The method of claim 9, wherein the structure is a recreational vehicle.

13. The method of claim 12, wherein:
the recreational vehicle has at least one slide-out; and
the support point is on the slide-out.

14. The method of claim 9, wherein the stable base is the ground.

15. The method of claim 9, wherein the cargo stabilization bar is a load bar.

16. The method of claim 9, where in the cargo stabilization bar includes a dampening mechanism.
